(19) United States
(12) Patent Application Publication
(10) Pub. No.: US 2013/0110974 A1
(43) Pub. Date: May 2, 2013

(54) METHOD AND APPARATUS FOR CONTROLLED SELECTION AND COPYING OF FILES TO A TARGET DEVICE

(71) Applicants: Juha Henrik Arrasvuori, Tampere (FI); Andrés Lucero, Tampere (FI); Mikko Antero Nurmi, Tampere (FI)

(72) Inventors: Juha Henrik Arrasvuori, Tampere (FI); Andrés Lucero, Tampere (FI); Mikko Antero Nurmi, Tampere (FI)

(73) Assignee: Nokia Corporation, Espoo (FI)

(21) Appl. No.: 13/659,351

(22) Filed: Oct. 24, 2012

Related U.S. Application Data
(60) Provisional application No. 61/553,570, filed on Oct. 31, 2011.

(51) Int. Cl. H04L 29/08

(52) U.S. Cl. CPC H04L 67/06
USPC 709/217

(57) ABSTRACT

An approach is provided for enabling controlled selection and copying of files from a source to a target device. A file sharing processor processes positional information associated with a first device and a second device to determine a relative position of the first device with respect to the second device. The file sharing processor then determines one or more criteria for causing, at least in part, a selection, a transfer, or a combination thereof of one or more files between the first device and the second device based, at least in part, on the relative position.

### RELATED APPLICATIONS

This application claims benefit of the earlier filing date under 35 U.S.C. §119(e) of U.S. Provisional Application Ser. No. 61/553,570 filed Oct. 31, 2011, entitled “Method and Apparatus for Controlled Selection and Copying of Files to a Target Device,” the entirety of which is incorporated herein by reference.

### BACKGROUND

Service providers are continually challenged to deliver value and convenience to consumers by providing compelling network services and advancing the underlying technologies. One area of interest has been the development of services and technologies for enabling file sharing and data exchange among device users. Typically, users may access large sets of files on a service or on another user's device by way of various communication techniques. However, depending on the size of the directory they are accessing and the number of files available, they may not be able to comb through all the files to decide which to copy. For this reason, some users resort to copying all of the available files to their device, then deleting the unwanted files at a later time. Unfortunately, this is not a practical solution as it may result in the retrieval and storing of irrelevant content. In addition, retrieval of a multitude of files can be significantly delayed by network traffic conditions or hindered by storage limitations of the target device.

### SOME EXAMPLE EMBODIMENTS

Therefore, there is a need for an approach for enabling controlled selection and copying of files from a source to a target device.

According to one embodiment, a method comprises processing and/or facilitating a processing of positional information associated with a first device and a second device to determine a relative position of the first device with respect to the second device. The method also comprises determining one or more criteria for causing, at least in part, a selection, a transfer, or a combination thereof of one or more files between the first device and the second device based, at least in part, on the relative position.

According to another embodiment, an apparatus comprises at least one processor, and at least one memory including computer program code for one or more computer programs, the at least one memory and the computer program code configured to, with the at least one processor, cause, at least in part, the apparatus to process and/or facilitate a processing of positional information associated with a first device and a second device to determine a relative position of the first device with respect to the second device. The apparatus is also caused to determine one or more criteria for causing, at least in part, a selection, a transfer, or a combination thereof of one or more files between the first device and the second device based, at least in part, on the relative position.

According to another embodiment, a computer-readable storage medium carries one or more sequences of one or more instructions which, when executed by one or more processors, cause, at least in part, an apparatus to process and/or facilitate a processing of positional information associated with a first device and a second device to determine a relative position of the first device with respect to the second device. The apparatus is also caused to determine one or more criteria for causing, at least in part, a selection, a transfer, or a combination thereof of one or more files between the first device and the second device based, at least in part, on the relative position.

According to another embodiment, an apparatus comprises means for processing and/or facilitating a processing of positional information associated with a first device and a second device to determine a relative position of the first device with respect to the second device. The apparatus also comprises means for determining one or more criteria for causing, at least in part, a selection, a transfer, or a combination thereof of one or more files between the first device and the second device based, at least in part, on the relative position.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of enabling controlled selection and copying of files from a source to a target device, according to one embodiment;

FIG. 2 is a diagram of the components of a file sharing processor, according to one embodiment;

FIGS. 3A-3C are flowcharts of a process for enabling controlled selection and copying of files from a source to a target device, according to various embodiments;

FIG. 4 is a diagram of an interface for configuring various settings of the file sharing processor via a user device, according to one embodiment;

FIGS. 5A-5R are diagrams depicting an interaction between one or more devices for enabling controlled selection and copying of files, according to various embodiments;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for enabling controlled selection and copying of files to a target device are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to file sharing conventions and techniques, it is contemplated that the approach described herein may be used with other data mining, data provisioning, file retrieval and exchange processing techniques. In addition, while various embodiments are presented primarily from the perspective of device-to-device data exchange, it is contemplated that any system or interface means for facilitating the transfer of data from a source to a target can be implemented. This includes, for example, touch or proximity based interfacing, device sensing, short range detection, point-to-point connection, virtual interfacing, ad-hoc networking, etc.

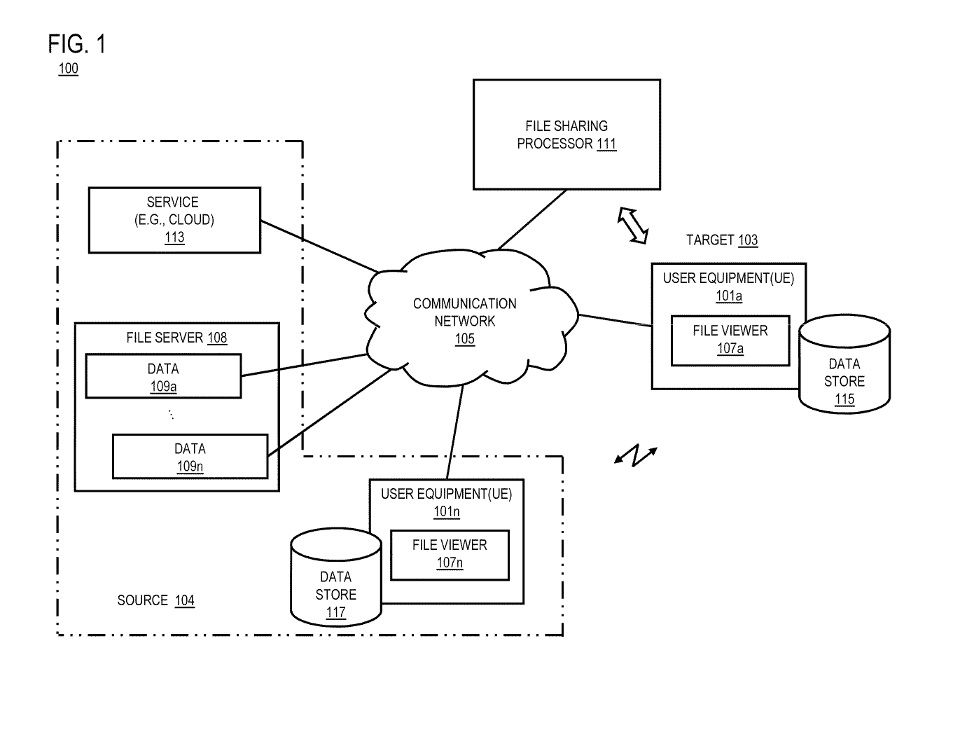

FIG. 1 is a diagram of a system capable of enabling controlled selection and copying of files from a source to a target device, according to one embodiment. By way of example, the system is configured to enable data, including files of various types (e.g., audio, video, documents, images), to be readily transferred to a target 103 from a source 104. Various file transfer initiation techniques are capable of being executed, such as by way of a file sharing processor 111, to initiate and facilitate source-to-target data transfer.

Many user devices nowadays, including cell phones, tablets and personal computers, are equipped with internal memory for storing music, documents, video and other types of data. In this way, the data can be readily accessed for use by various applications operable on the device or shared with other device users via a file transfer technique (e.g., infrared), cable based coupling, etc. In addition, these devices are configured to access various network based data sources, including file servers, cloud systems, backup services, etc. Data synchronization techniques may also be employed to ensure that data maintained on one device is in parity with that maintained at another device or network data source. Data may be retrieved by from both local and network based storage mediums.

Still further, devices may be implemented with various sensors and data transfer applications for supporting the exchange of data. The sensors may include pressure sensors, motion sensors, proximity sensors and the like for detecting various inputs (e.g., an amount of pressure, an overlapping of devices, a proximity condition) that may be translated into a file transfer command. For example, pressure data may be used deciphered as being representative of a user touch for selecting a file resident on a device. The user can then facilitate transfer of the file to a target device by activating a “send to” function (e.g., applying pressure to the interface corresponding to a tap and hold) and then indicating the target device to send the data to. Under this scenario, the file exchange protocol may be Bluetooth or some other proximity based scheme.

The file as received by the target device is typically maintained in a generic “inbox.” The recipient must then move the file from the generic inbox to a desired location, such as dedicated folder, directory or network data store. In cases where a collection of files are received, the user must repeat this process for each file. Unfortunately, this process is tedious for the recipient as they must manually direct the data to the proper storage location. Unfortunately, there is no intuitive means for copying files from a source device to a precise location of the target device.

Also, when accessing a particular data source from which to retrieve data, device users may not have time to review each individual files in order to decide which they want or which is most relevant for their needs. In addition, the organization of files at the data source may differ from what the accessing user is accustomed to, making it difficult to know exactly which folder or subfolder contains the needed information. The larger the data source, the more daunting it is for a user to pinpoint specific information of interest. For this reason, some users resort to copying all of the available files to their device then deleting the unwanted files at a later time. However, this is not a practical solution as it may result in the retrieval and storing of irrelevant content. In addition, the retrieval of a multitude of files can be significantly delayed due to network traffic conditions or hindered by storage limitations of the target device (e.g., not enough internal memory). Hence, the user has limited control over what specific data is or is not transferred within a given set of files.

To address this problem, a system 100 of FIG. 1 introduces the capability to support the sharing of data, such as files and other information, on the basis of specific selection criteria. By way of example, sharing is facilitated between devices on the basis of a defined data type, keyword, or other specific parameter as well as on a proximity condition, orientation, overlap or other condition of the devices relative to one another. In certain embodiments, the system 100 includes a file sharing processor 111 that is configured for operation by a device to enable users to interact with one another to exchange data. For the purpose of illustration, the file sharing processor 111 is presented as a component operable for direct execution by a device, i.e., user equipment (UE) 101. By way of this approach, the file sharing processor 111 is executed by the source, the target, or both to initiate and subsequently execute file copy and transference. Under this approach, the file sharing processor 111 may be implemented as a software executable, hardware executable, or a combination thereof. Alternatively, the file sharing processor 111 may be accessed via a communication network 105 as a service or platform. In either implementation, the processor 111 is configured to facilitate a file sharing communication between a source 104 and a target 103.

The target 103 may be user equipment (UE) 101a that maintains a data store 115 for storing data as copied from a data source 104; the target 103 being referred to herein as a target UE 101a. The data source 104 may also be user equipment (UE) 101n that maintains a data store 117 for storing data; the UE 101n being referred to herein as a source UE 101n. In addition, the source 104 may also be a service 113 such as a cloud or a file server 108 for storing various data 109a-109n. Data maintained by the source 108 may include, for example, files of various types, sizes and structures. This may include music files, video files, documents, applications, etc. In the case of a target UE 101a and source UE 101n, the respective devices may operate a file viewer 107a and 107n for retrieving, viewing, opening or selecting files. The file viewer 107 may be configured to interact with the file sharing processor 111 accordingly.

In certain embodiments, the file sharing processor 111 performs one or more of the following: (1) defines specific criteria and/or requirements to be met for controlling the selection of files to be transferred to a target 103, i.e., UE 101a, from a source 104; (2) enables partial copying of files from the data source 104; (3) initiates transfer of files based on proximity, touch characteristics, device orientation and other physical stimuli and/or keyword based input. Partial copying of files may include, for example, copying of a percentage, subset or portion of a selected range of files to a target based on user specified criteria. Hence, the subset of files comprising the partial copy may in some instances differ from the selected range of files available for copy.

In addition, the file sharing processor 111 enables partial copying may be facilitated between devices based on a representation of a data extraction or attraction tool. In certain embodiments, the data extraction or attraction tool may be rendered to a graphical user interface of the target 103, i.e., UE 101a. The tool may include, for example, a pipette tool, a magnet, a vacuum or any other icon for representing the data retrieval process. In the case of a pipette, the tool may be metaphorically aligned with the data extraction operation. Hence, the user can mimic air suction by squeezing the target device featuring the pipette and then release the squeeze to initiate content transfer. The icon is further associated with the defined criteria and/or requirements to be met for controlling the selection of files to be transferred to the target 103. In addition, the icon enables initiation of the file transfer process based on its proximity to one or more files of the source 104.

From a large selection of files, the file sharing processor 111 permits only a partial/portion/subset of files to be copied from a source UE 101n to a target UE 101a or from a service 113 or file service 108 to the target UE 101a. The size of the subset is defined by drawing a certain area on a display of a device 101 via touch input provided by the user of UE 101. The touch input may include, for example, multi-touch interaction, touch pressure information, etc. Alternatively, the size of the subset is defined by the selection of an area of the display via a mouse or other selection tool. In this example, the selected area becomes the percentage of the subset.

Alternatively, the size of the subset for dictating the partial copy may correspond to the area of display of the source UE 101n and the target UE 101a as they overlap. Under this scenario, the overlapping area becomes the percentage of the subset. It is noted that the overlap may include placement of the target UE 101a atop the source UE 101n in whole (100%) or in part. The display of the target UE 101a may be caused to reflect the content—i.e., files, subfolders, folders—displayed by the source UE 101n corresponding to the area of overlap.

The partial copy may also be based on an amount of folding the source UE 101n undergoes. For example, if the source UE 101 n is folded, collapsed, closed or reduced by half, then the size of the subset is 50%. This folding action may be the result of a flipping or sliding action of the UE 101n or some other adaptation of the form factor of the device. Also, the file sharing processor 111 may facilitate a defining of the subset based on one or more keywords culled from the metadata of all files at the data source 104 from the original selection of files as drawn, selected by stylus or mouse, etc. As such, metadata containing specific matching keywords may be used to restrict the number of files that is subject to the partial copy. Still further, the files included in the partial copying for transfer may also be determined automatically by the system based on selection criteria. For example, the selection criteria may include data for indicating a relevancy of a specific file, such as based on a date, a file type, a file size, a relationship of a file to a particular application, a ranking or user rating, or other criteria. Other selection criteria may include, for example, interest profile information (e.g., music type or genre, document type), a popularity ranking, a communication network status (e.g., if data 109a-109n is to be retrieved from a service/cloud 113), an amount of free space available at the data store 115 of the target UE 101a. The selection criteria are specified by the user of a target device, i.e., UE 101a. In the case of the amount of space at the data store 115, a query may be performed by the target UE 101a to return a value representing the amount of memory available. The selection criteria enable automatic or semiautomatic file selection from among a vast array of selected files at the data source 104.

As noted, the file sharing processor 111 also enables files to be selected and copied from a source device to a target device via a data extraction and/or attraction means. By way of example, keywords may be entered by the user or presented for selection based on the culling of the metadata—i.e., as a pipette tool, spinning keyword wheel, etc. More specifically, a corner of a user interface for a target device 101a may feature an icon representing a pipette tool, magnet, etc. The tool may further define keywords that serve as descriptors and/or criteria of the type of files to copy from the source device (or vice versa).

In certain embodiments, placing the corner featuring the tool (e.g., pipette) physically next to a representation of a folder at the display of a source device 101n causes any files matching the tool and associated keyword to be copied. Under this scenario, a pipette tool with associated criteria and/or keywords of “Photos” causes only those files corresponding to an image/photo format to be copied from the specific folder at the source device 101n. Thus, a partial copy interaction is facilitated as not necessarily all the files in the selected folder are copied. It is noted that, in certain embodiments, the keywords may also be complex search sentences, conditional criteria (e.g., specific file types, formats, and dates), etc.

As shown in FIG. 1, the system 100 comprises user equipment (UE) 101 having connectivity to a file sharing processor 111 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.). In addition, the file sharing processor 111 may be integrated for use by the UE 101 to facilitate the transfer of data by way of various interface communication means. This includes, for example, execution of various touch or proximity based communication schemes, short range communication techniques or point-to-point connectivity protocols.

In certain embodiments, the UE 101 operates a file viewer 107, an independent application for enabling the retrieval, organizing, viewing, or storing of files, or representations thereof, at a data store 117. By way of example, the file viewer 107 may render a user interface to a display of the UE 101. Under this scenario, the file viewer 107 may include various controls, menus and selection buttons for enabling a user to view a representation of data corresponding to specific selection criteria. The representations may correspond to, for example, one or more icons, images or visual and/or interactive depictions of folders, subfolders and associated categories or types of files. As such, the representations may correspond to various file types including word processing documents, music files, digital photos, e-mail messages, web pages and the like. For the purpose of illustration, the various representations as presented herein via a file viewer 107 are described herein as files.

The file viewer 107 may also include various controls for enabling a user to establish naming conventions for various documents, establish access and/or permission settings, add metadata and file property information, etc. It is noted that the file viewer 107 may operate in connection with various other applications at the UE 101, including by way of an application programming interface (API) call for invocation in response to an application request. As such, the various executions of the file viewer 107 may be activated in connection with another application operable at the UE 101, i.e., a word processing application, media player application, directory service, etc.

By way of example, the UE 101, file sharing processor 111 and various sources 104 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

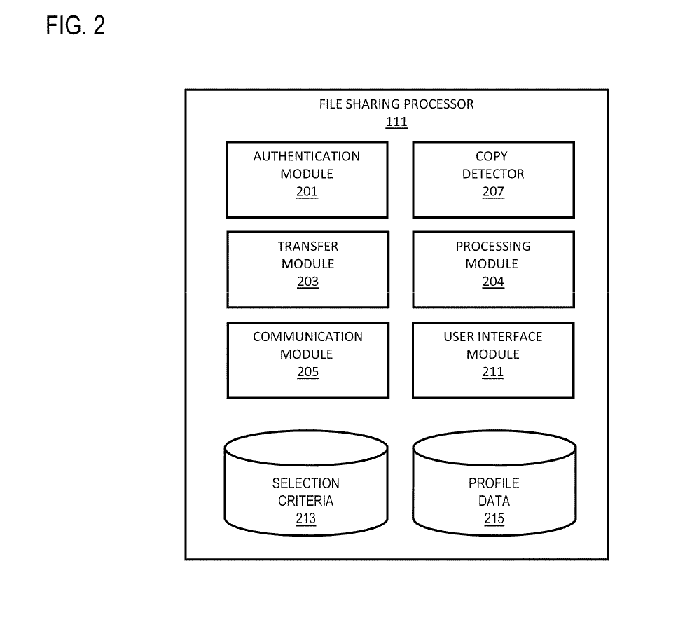

FIG. 2 is a diagram of the components of a file sharing processor, according to one embodiment. By way of example, the file sharing processor 111 includes one or more components for enabling controlled selection and copying of files from a source to a target device. It is contemplated that the functions of these components may be combined in one or more components or performed by other components of equivalent functionality. In this embodiment, the file sharing processor 111 includes an authentication module 201, a transfer module 203, communication module 205, copy detector 207, processing module 204 and user interface module 211.

In addition, the file sharing processor 111 may be configured to maintain selection criteria and profile data at respective databases 213 and 215. The selection criteria include data established by the user of a device for indicating various conditions for enabling file transference from a source to a target. As noted, the criteria may include data for specifying user interest information, a popularity ranking, a relevancy factor, etc. In addition, the selection criteria may correspond to a condition, such as a required amount of space at a data store relative to the size of one or more files to be copied. Still further, the selection criteria may correspond to a network condition, such as an amount of bandwidth or availability/status of a server. The actual selection process is facilitated on the basis of the criteria via one or more device interaction and/or user interface selection means.

In one embodiment, an authentication module 201 authenticates users and user equipment 101a-101n for interaction with the file sharing processor 111. By way of example, the authentication module 201 enables a user to configure selection criteria 213 for affecting the transferring of files from the source to the target. The authentication module 201 may therefore operate in connection with a user interface module 211 for causing rendering of an interface for receiving user input regarding the selection criteria. In addition, the authentication module 201 enables the establishing of profile data 215 for configuring various settings, tolerances, reactions and preferences of the user and/or user equipment. Preferences and settings information can be referenced to a specific user, user equipment, or combination thereof. The profile data 215 may also facilitate one or more rights and permissions for permitting access to a data source.

In one embodiment, the copy detector 207 operates in connection with various sensors of UE to initiate the file selection process. The file selection process is performed as a precursor to the copy and/or transfer process in order to specifying a quantity of files, folders, subfolders, or other representations to be copied and/or transferred. The copy detector 207 enables selection of specific files to be copied based on various input means, including by way of a mouse, text input, stylus or hand gesture. It is contemplated as well that the copy detector 207 may recognize an image input for representing a number of files to select for copy and/or transfer. By way of example, the copy detector 207 may detect a keyword as input at a file viewer application for specifying a particular file name, file property or metadata for searching through a number of files at a source. The keywords may correspond to global positioning system (GPS) coordinates, ratings (“stars”) attributed to the file, statistical data such as the chart position of a song within a top 50 list, sales statistics associated with of an application, etc. Alternatively, the copy detector 207 may operate with the user interface module 211 to render various keyword selection options to a display of an interacting device.

In certain embodiments, the authentication module 201 may maintain profile data for enabling a user to customize a data extraction and/or attraction tool to be rendered to a GUI of a device for supporting file selection. By way of example, a user may select from a menu of icons representative of various tools, including a pipette tool, a magnet, a spinning wheel, a vacuum, and various other icons. The authentication module 201 may also be configured to enable user customization of an image for representing the tool. It is noted that the authentication module 201 operates in connection with the user interface module 211 to enable the presentment of a configuration interface for defining various user preferences and settings.

As another example, the copy detector 207 determines a number of files to be selected and/or transferred via a hand drawn area of the device touch screen. Under this scenario, the area as drawn may correspond to a highlighting of a select number of representations of files within the drawn area. It is noted that the copy detector 207 may detect touch pressure or multi-touch input by interfacing with various sensors of the device (e.g., touch screen sensor) or by receiving a notification of an input. Furthermore, the copy detector 207 may perform various data mining, retrieval and file selection techniques at the source based on the provided input.

Still further, the copy detector 207 is configured to determine a number of files to be selected and/or transferred based on the orientation and/or placement of a tool at or near a corresponding portion of a display of a source device. By way of example, the copy detector 207 enables a pipette tool of other icon representative of a data extraction or attraction process to be limited to a specific set of criteria. Under this scenario, only those files corresponding to the criteria—i.e., a keyword, file type, condition—are detected and flagged for copying. Subsequently, only those files determined to meet the criteria are enabled to be transferred by the transfer module 203.

The copy detector 207 may also be configured to determine a proximity condition is met between the source and the target device or may sense an overlapping of the source and target device. Furthermore, the copy detector 207 may also determine the execution of one or more gestures, motions or commands. Based on these determinations, the copy detector 207 triggers the file selection process as well as invokes the transfer module 203 to initiate the copy and/or transfer process. For example, the copy detector 207 may enable selection of a set of files totaling 100 based on a sliding of the user's hand across a display of the source UE. The copy detector 207 may be configured to interpret the sliding (or other gestures at the display) as defining a drawn area representing the selection of files. Still further, the copy detector 207 may interpret a sliding of a target device featuring a pipette tool at a corner of its user interface to correspond to a selecting of a specific file type across multiple folders at the source. In each of these examples, the action serves as input to trigger activation of the transfer module 203 for initiating the copy and/or transfer process—i.e., presentment of a copy and/or transfer command—based on the specific criteria to be met. Activation of the copy and/or transfer command alerts the transfer module 203 of incoming input regarding a copy and/or transfer action.

The copy detector 207 is also configured to operate in connection with a processing module 204. The processing module 204 translates pressure data, orientation data, and other sensory stimuli gathered at a device into a copy and/or transfer command accordingly. By way of example, the processing module 204 receives input for representing an extent of squeezing or pressure application at the target device (e.g., pressing of the user interface of the target device with a certain number of fingers). Based on these stimuli, the processing module 204 enables the amount of pressure/touch input to correspond to the amount of content copied or the speed of copying. Also, the amount of pressure or number of fingers pressing the display may define how many rows are transferred from a grid of representative content. It is noted that the copy detector 207 relies on the processing module 204 to account for various external and/or device internal characteristics that correspond to the selection of files to be copied in accordance with defined criteria.

In certain embodiments, the copy detector 207 also detects a gesture representing a drawn area at the display of the target UE. This includes detecting interaction information at the touch screen of a device, including multi-touch interaction and touch pressure information. Input detection triggers notification of the transfer module 203 to enable partial copying, wherein the percentage of files copies and/or transferred is proportional to the drawn area of the display of the target UE. By way of example, a drawn area of 30% of the display of the target UE represents a copying and/or transfer of 30 files to the target UE from the source. It is noted that a proximity condition may be established between the target UE and the source for enabling the above described interaction.

As another example, the copy detector 207 may determine that a number of files presented to a display of a source UE is to be selected based on a sliding motion of the target UE across the display of the source. The copy detector 207 is able to interpret the sliding gesture as a user command to select all of the files as presented to the display. Hence, if the number of files presented to the display of the source (e.g., via a file viewer) is 100, this represents the entire selection. Once the selection is made, the copy detector 207 also detects a subsequent overlapping of the area of display of the source UE and target UE. For example, the target UE may overlap a portion representing 20% of the display of the source UE. Under this scenario, the 20% area of overlap is determined to represent a subset of the selected files. In the case of the previous example of a selection of 100 files, the subset corresponds to 20 files (20% of 100 files). Hence, the subset represents those pursuant to partial copy—i.e., initiated for actual copy and/or transfer by the transfer module 203.

It is noted that content displayed on the source UE or by a service acting as the source may be duplicated on the screen of the target device to give the user an illusion of a “transparent” device. In certain embodiments, the replicator module 204 operates in connection with the copy detector 207 to translate content across devices in real-time. The replicator module 204 may also synchronize device actions such that actions at the source UE are mimicked at the target UE. As such, a rendering of various representations of one or more files, folders or subfolders at the source is also caused to be rendered to a display of the target UE.

The copy detector 207 is also configured to detect a change in orientation, form factor, size, or positioning of a source UE. By way of example, the amount of folding of a source UE may define the amount of selected files to be copied. Under this scenario, the copy detector 207 may interact with various sensors of the source UE to detect the folding. A folding of the device in half corresponds, therefore, to a selection of 50% of all selected files. In the case of 100 files being selected, only 50 files are subject to partial copying.

In one embodiment, the transfer module 203 facilitates transfer of files/data from a source based on the established selection criteria 213. By way of example, the transfer module 203 processes the selection criteria as processed by the copy detector 207 to determine which files match to the criteria (or condition set forth as criteria). A matching of the criteria then establishes which of the files corresponding to the representative total of those selected is to be copied and/or transferred from the data source. Selection criteria may include, for example, determining of:
a. files matching an interest profile or generic popularity of the files (e.g., only the greatest hits from a music album);
b. a network condition or network coverage status (e.g., when files are retrieved from a cloud);
c. an amount of free file space on the target UE; and
d. files corresponding to a keyword, such as that corresponding to a pipette tool.

It is noted that the interest profile may relate to a relevancy factor. As such, files are selected depending on a ranking, popularity, redundancy of the content (e.g., from a collection of holiday photos only one photo from each sightseeing location is copied), date, version, etc.

By way of example, when the criteria calls for network signal strength of “Excellent” OR “Good” to commence file copying, this condition is determined by the transfer module 203. The criteria may also call for the copying of files corresponding to a particular media type and file format—i.e., only audio generated in MPEG-1 or MPEG-2 Audio Layer III (MP3) or Waveform Audio File Format (WAV) formats. Under this scenario, the transfer module 203 may interface with a network connection signal of the UE to determine the signal strength or query the connectivity status via the communication module 205. When the network condition is met, the transfer module 203 then flags any MP3 and WAV audio files from among the set of those selected via the copy detector 207. Hence, it is noted that of the plurality of representations selected via the copy detector 207, only those files meeting the required criteria are ultimately established for transference and/or copy.

The transfer module 203 is also configured to be triggered by the interaction of a source UE and target UE relative to the placement, orientation and selection of files via a tool for defining keywords or other selective file copy criteria. For example, in the case of a pipette tool being rendered to the display via the user interface module 211, an opening end of the pipette as directed to a file may signify a transfer process is to be initiated. As another example, a magnetizing end of a magnet may be directed to a specific file or folder for enabling the transfer process. As noted, the transfer module 203 enables transfer of only those files corresponding to the criteria—i.e., those flagged by the copy detector 207.

In one embodiment, the user interface module 211 enables presentment of a graphical user interface for configuring the file sharing processor. By way of example, the user interface module 211 generates the interface in response to application programming interfaces (APIs) or other function calls corresponding to the browser application or web portal application of the user devices 101a-101n; thus enabling the display of graphics primitives. The user interface module 211 may operate in connection with the authentication module 201, transfer module 203, copy detector 207 and processing module 204 to support various interactions with the user, including for example: establishing one or more relevancy criteria, establishing selection criteria, rendering user command action messages (e.g., copy or transfer command action), etc. It is noted that the user interface module 211 may operate in accordance with various operating system environments for supporting the rendering of one or more representations of one or more files.

In one embodiment, a communication module 205 enables formation of a session over a network 109 between the file sharing processor 111 and the data source. By way of example, the communication module 205 executes various protocols and data sharing techniques for enabling collaborative execution between UE 101a and 101n (e.g., mobile devices, laptops, smartphones, tablet computers, desktop computers) via the network 105. It is noted that the communication module 205 is also configured to support a browser session—i.e., the retrieval of content as referenced by a resource identifier during a specific period of time or usage of the browser. The browser session may support execution of file transference via a service (e.g., cloud), a remote file server or other network based resources.

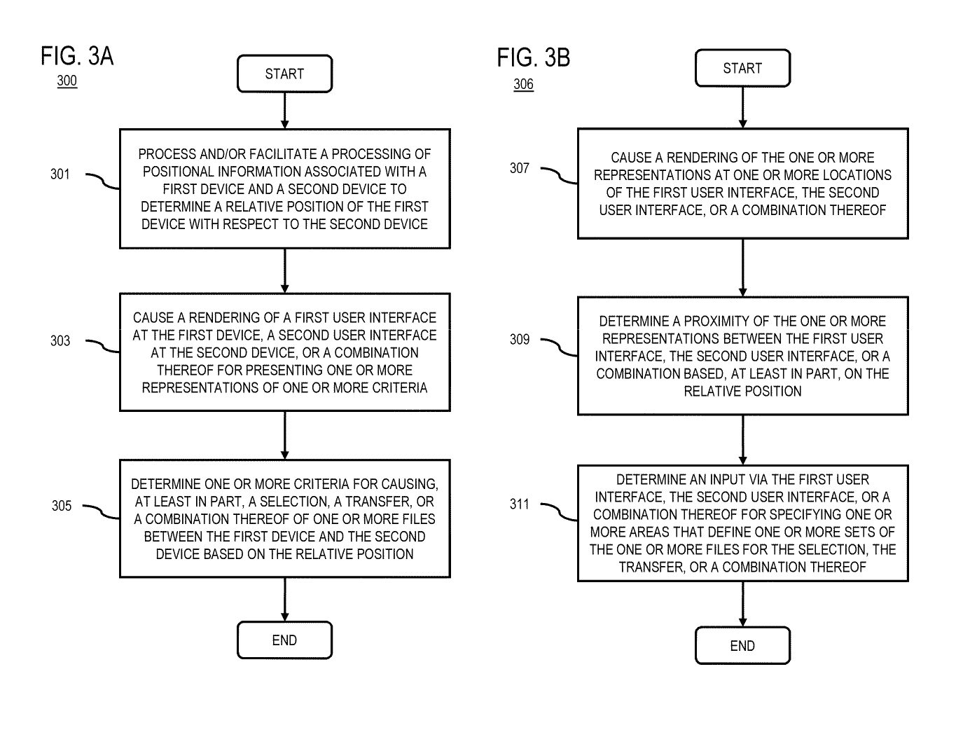

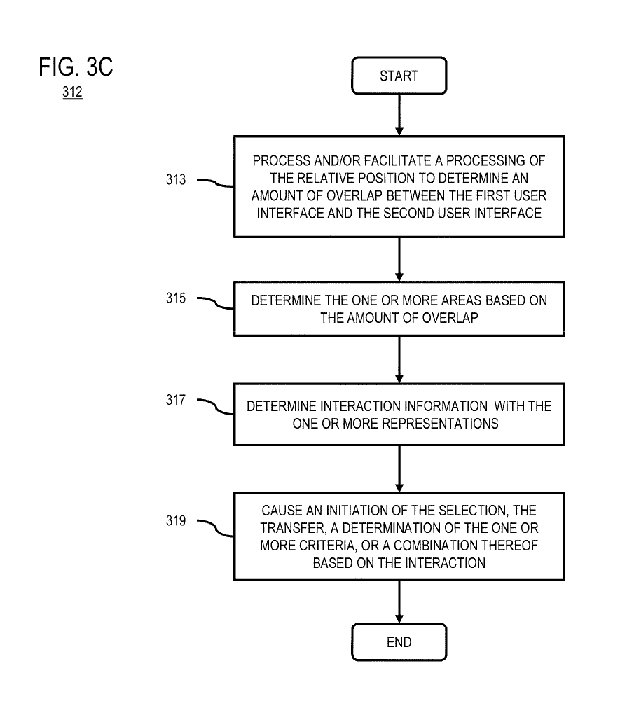

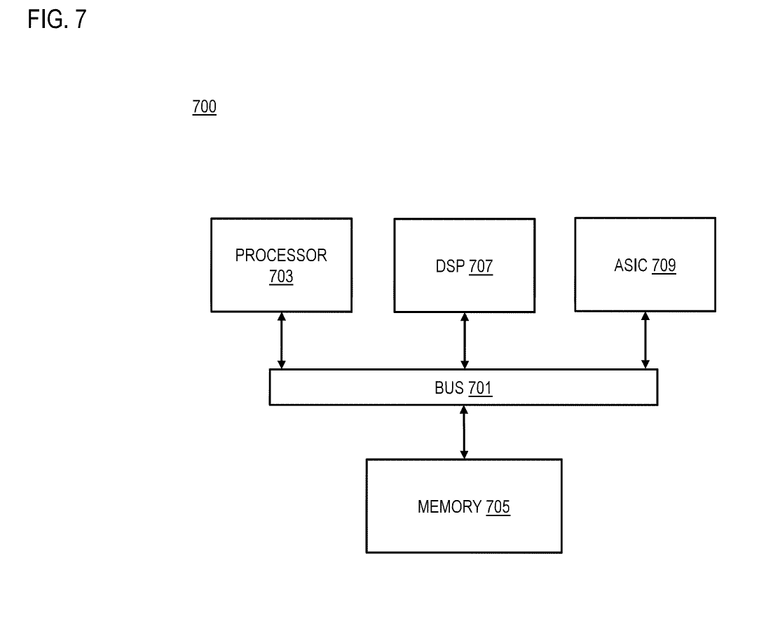

FIGS. 3A-3C are flowcharts of a process for enabling controlled selection and copying of files from a source to a target device, according to various embodiments. In one embodiment, the file sharing processor 111 of FIG. 1 performs processes 300, 306 and 312 and is implemented in, for instance, a chip set including a processor and a memory as shown in FIG. 7. In step 301, the file sharing processor 111 facilitates a processing of positional information associated with a first device and a second device to determine a relative position of the first device with respect to the second device. By way of example, the first and second devices may correspond to a source UE 101n and target UE 101a respectively. The positional information may include data representing a proximity threshold between respective devices (e.g., side-by-side placement) or an overlapping condition. Per step 303, the file sharing processor 111 causes a rendering of a first user interface at the first device, a second user interface at the second device, or a combination thereof for presenting one or more representations of one or more criteria. As noted, the criteria may be associated with a representation of a tool—i.e., a magnet or pipette—for facilitating a file selection and/or transfer. Also, the first user interface includes, at least in part, one or more control elements for manipulating, processing, or a combination thereof the one or more files rendered in the second user interface. Control elements may include, for example, a copy command action for initiating a copy process, a transfer command action for initiating a transfer process, various hand gestures or touch based controls, etc.

In step 305, the file sharing processor 111 determines one or more criteria for causing, at least in part, a selection, a transfer, or a combination thereof of one or more files between the first device and the second device based, at least in part, on the relative position. As noted previously, the one or more criteria may include one or more file types, one or more keywords, one or more data representations (icons) associated with the one or more keywords, or a combination thereof. In addition, the criteria may be related to various conditions, including network conditions, a popularity ranking, a relevancy factor, etc. This execution corresponds to a partial copying of the selected files—i.e., copying and/or transfer of a percentage, subset or portion of a selected range of files to a target based on user specified criteria. Hence, the subset of files corresponding to the criteria (corresponding to the partial copy) may in some instances differ from the overall selected range of files.

In step 307 or process 306 (FIG. 3B), the file sharing processor 111 causes a rendering of the one or more representations at one or more locations of the first user interface, the second user interface, or a combination thereof. The locations of the first and second user interface correspond to at least a portion of said interfaces for presenting the representations of the one or more files to be potentially copied and/or transferred. Also, the relative position, orientation and/or placement of a representation at one interface relative to the other user interface correspond to a selection and/or transfer process.

Per step 309, a determination is made by the processor 111 of the proximity of the one or more representations between the first user interface, the second user interface, or a combination thereof. This determination is made based on the relative position of the displays of a respective source and target UE. In addition, the one or more criteria for enabling selection of one or more files—i.e., a subset of files corresponding to the one or more representations thereof—is based at least in part on the proximity. As noted, the proximity may include a side-by-side pairing, an overlapping, etc. By way of example, a representation of a pipette tool to an interface of the target device may be oriented towards, placed in proximity to, or directed towards a representation of a file folder at a source device. Hence, relative portions of said interfaces contribute to the means of file sharing interaction between devices.

In step 311, the file sharing processor 111 determines an input via the first user interface, the second user interface, or a combination thereof for specifying one or more areas that define one or more sets of the one or more files for the selection, the transfer, or a combination thereof. As noted, in addition to touch based input, the input may also include a change in form factor of a given device. Various technologies can be used to fold a device to provide the input. For example, a foldable or collapsing clamshell device can be folded into half to thus reduce its form factor. Also, it is contemplated that known or currently developing elastic materials for manufacturing bendable/foldable devices can be used. As such, a device may be folded multiple times and in different shapes to form a device and/or display “footprint” that is less than its original size. It is noted, therefore, that the amount of folding of the device defines the amount of files to be copied.

In step 313 of process 312 (FIG. 3C), the file sharing processor 111 processes the relative position to determine an amount of overlap between the first user interface and the second user interface. Also, in steps 315 and 317, the file sharing processor 111 determines the one or more areas based on the amount of overlap as well as determines interaction information with the one or more representations. By way of example, the relative position may include an orienting of a target device such that one of its corners is pointed towards a source device. The corner may correspond to a location of a representation of a data extraction and/or extraction tool, i.e., a pipette tool or other icon. In other instances, the relative position may correspond to an extent of distance of the source device and target device from one another.

The interaction information may correspond to the determination of various stimuli as applied to the source device and/or target device. For example, an amount of pressure applied by a user of a target device may be determined as interaction information for enabling a device to access one or more representations of files at a source. As another example, a sliding of a target device relative to a source device may be determined as interaction information for enabling the detecting and initiating of a copy or transfer of files. Per step 319, the file sharing processor 111 causes an initiation of the selection, the transfer, a determination of the one or more criteria, or a combination thereof based on the interaction. It is noted, therefore, that a combination of stimuli, gestures and other actions may be executed for enabling the file sharing to commence.

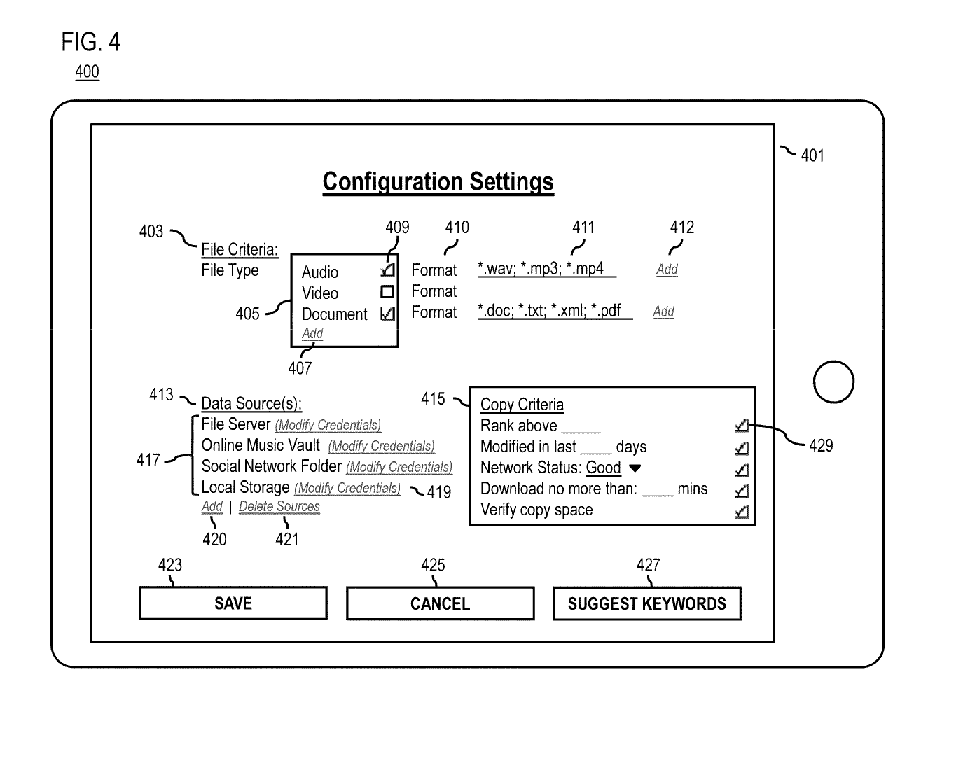

FIG. 4 is a diagram of an interface for configuring various settings of the file sharing processor via a user device, according to one embodiment. The configuration interface 401 includes various controls for allowing a user of a device, i.e., UE 101 of FIG. 1, to affect file sharing interaction. This includes, for example, the establishing of one or more file selection criterion for enabling partial copy of a selection of files.

By way of example, file criteria options 403 may be established for designating specific file types 405 to be selected. The file types as shown in the example include audio, video and document. The user may add additional file types by selecting the Add line 407, which renders a list of other types of content available for selection. A checkbox, i.e., check box 409, is featured next to each file type for enabling the user to activate (check) or deactivate (uncheck) a particular file type for processing by the file sharing processor 111. Activation or deactivation of the various checkboxes (i.e., checkbox 409) enables the user to readily indicate which file types within a selection are eligible for copy and/or transfer.

In addition, the user may also select a specific file format 410 corresponding to each file type 405. By way of example, when the user activates the checkbox 409 corresponding to the audio file type, a data entry section 411 is presented for enabling the user to indicate specific audio file formats for selection. The user may select from a list of known audio file formats from a menu as rendered to the interface 401 by selecting the Add link 412. Alternatively, the user may enter the corresponding file types manually at the data entry section 411. Manual entry may also include the defining of a unique file format by the user, such as a file format corresponding to an unknown, non-commercial or proprietary software package. In the example as shown, the file formats selected by the user with respect to audio include the WAV (waveform audio file format), MP3 (MPEG-1 or MPEG-2 Audio Layer III) and MP4 (MPEG-4 Part 14).

The user may also establish one or more data source options 413 for indicating one or more data stores to be made available for access by another device. It is noted that the data source options 413 enables the device 400 to serve as a data source. In addition, the user may specify various external data sources accessible to the user. It is noted that the local and external data sources as specified may be accessed and viewed by way of a file viewer or other similar application of the device 400. The data sources 417 as shown by way of example may include a file server, online music vault, music directory maintained at a social networking site and the local data store of the device 400. A Modify Credentials link 419 may be selected to enable the user to modify the access settings, requirements and permissions of the resource. In addition, an Add link 420 and Delete Sources link 421 may be selected to add or delete sources from the list 417 accordingly.

The user may also specify one or more copy selection criteria options 415. Criteria may be activated by way of a checkbox (e.g., 429) corresponding to each criterion, as well as user input to specify a particular setting (e.g., a ranking level of 5). By way of example, the criterion include a specifying of a file ranking, a date of last file modification, a network status/condition, an desired download time and a file space verification condition. It is noted that the user may also specify various keywords for enabling a file search of the data source by selecting a Suggest Keywords action button 427. Upon selection, another interface is rendered for enabling user entry of various keywords to be culled from metadata regarding the various files at the source.

When the user is finished, they may save the various settings by selecting a Save action button 423 or cancel the settings by selecting a Cancel action button 425. The user may establish one or more default settings for enabling of the above described criteria. While not shown, the user may also select a particular representation of a data extraction and/or attraction tool to be used for interacting with a source device. By way of example, the user can select a pipette tool, magnet, or any other icon to use in representing a definitive keyword or other file selection criteria. In addition, the user can establish various pressure release, data transfer speed or other settings in connection with the selection of the particular tool. Hence, a setting for regulating an amount of detected squeezing of a target device or an amount of speed for representation of a data transfer may be adjusted.

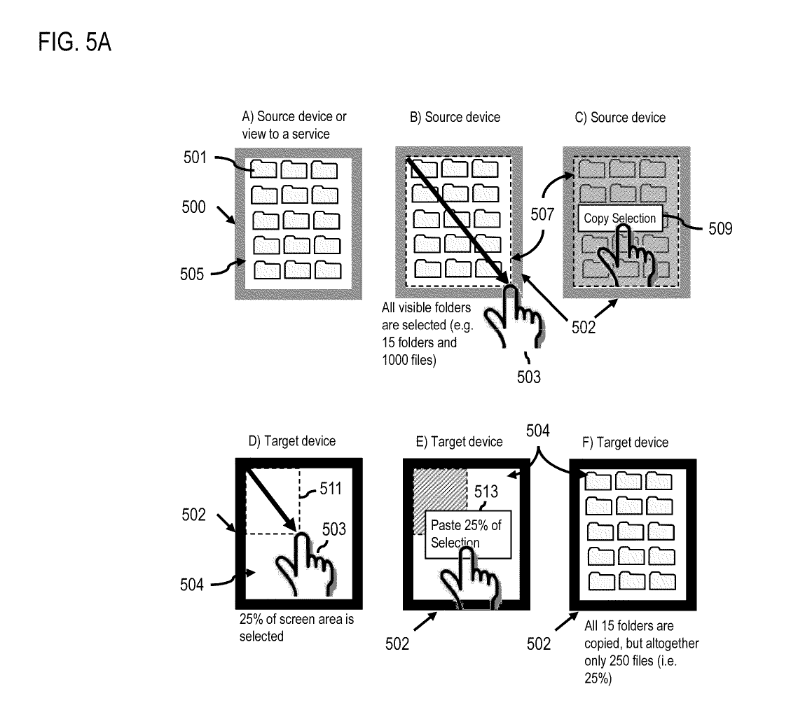

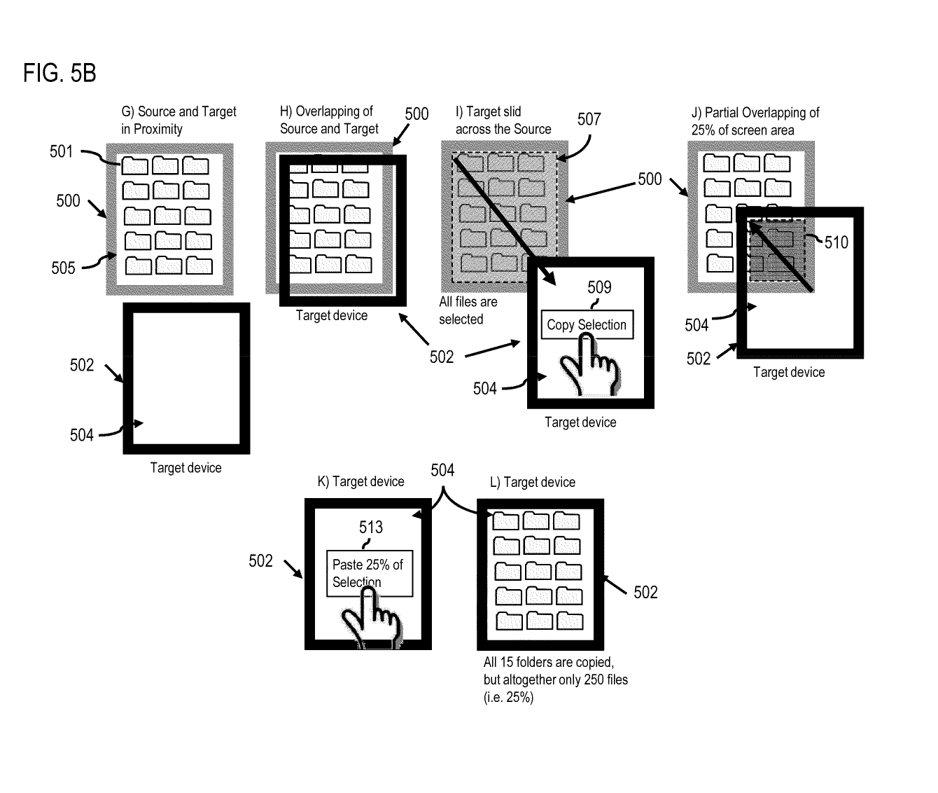

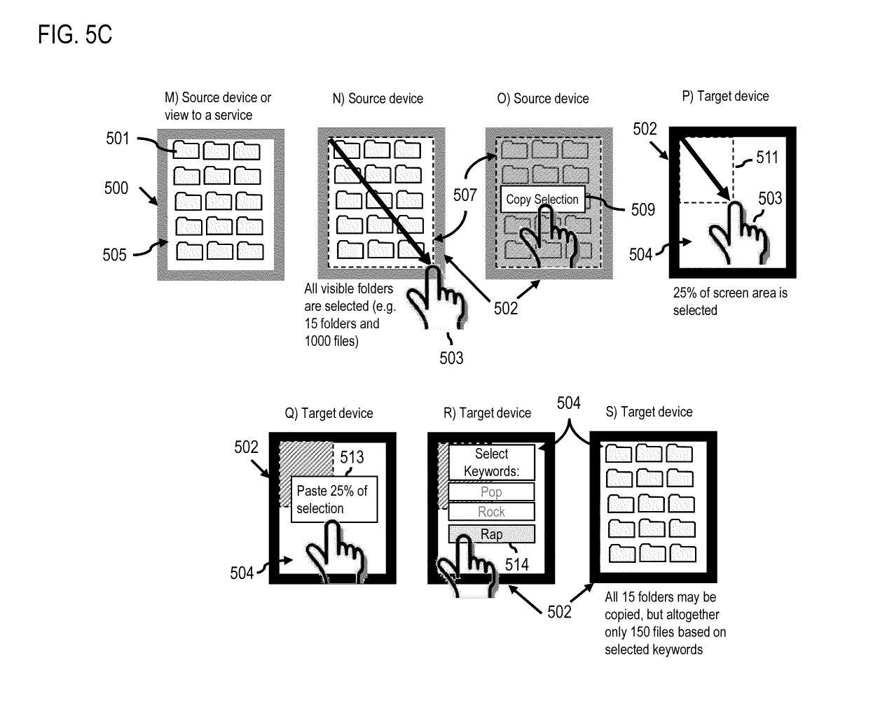

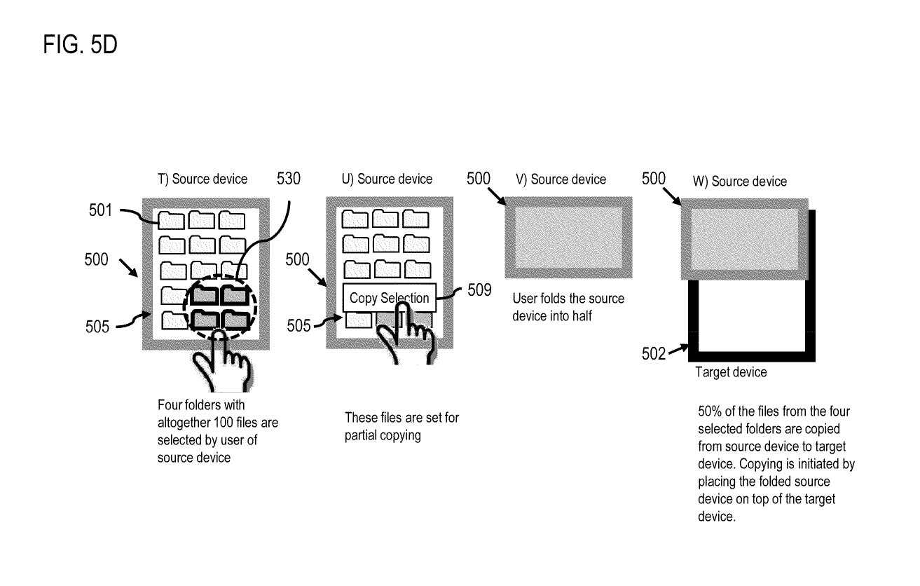

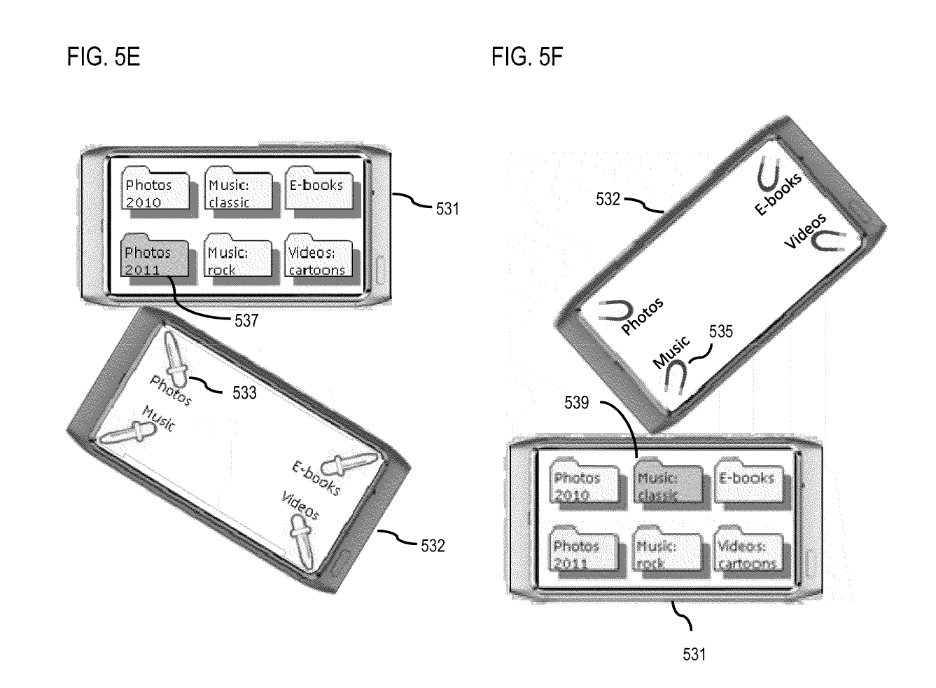

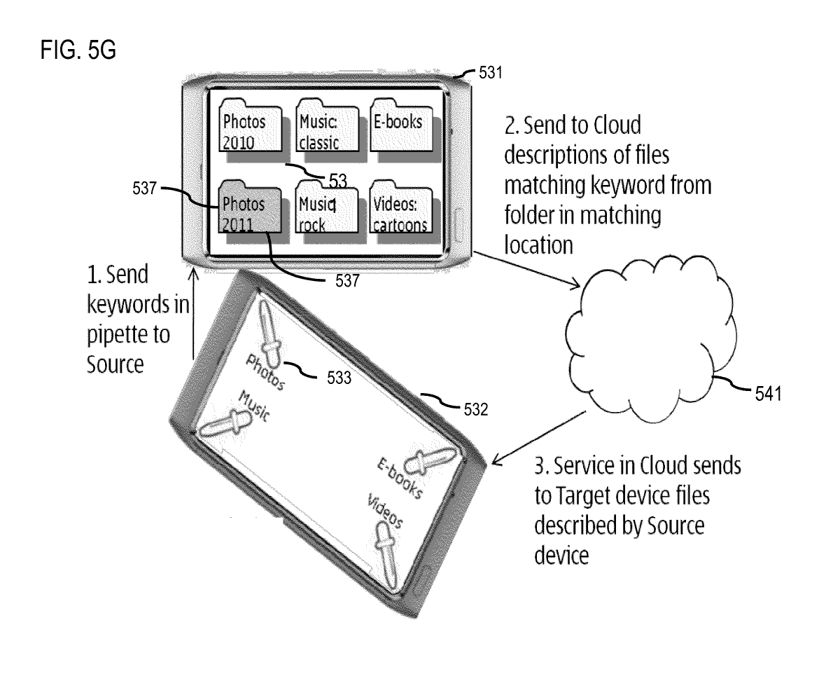

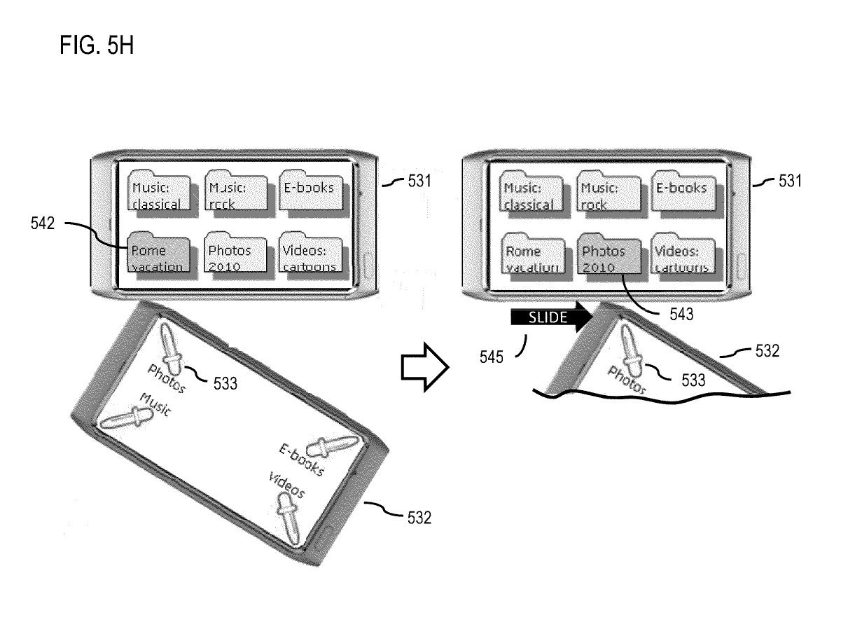

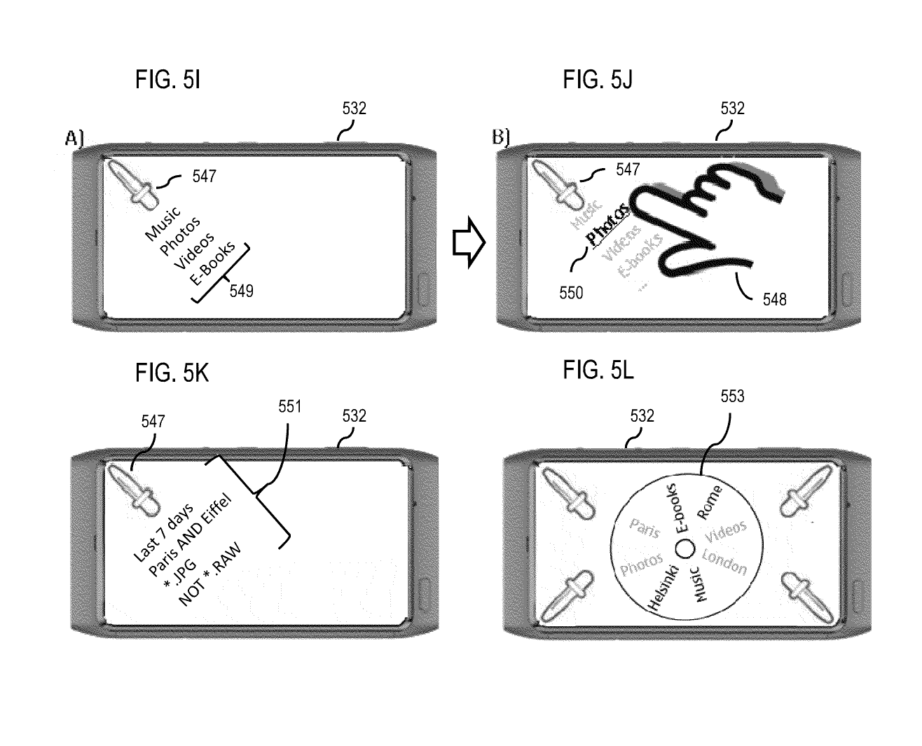

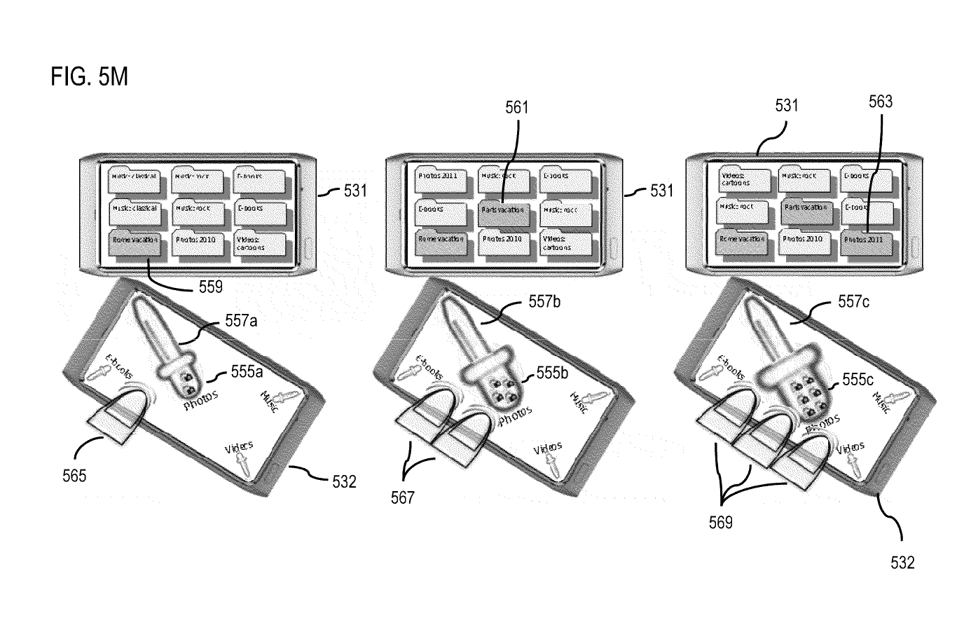

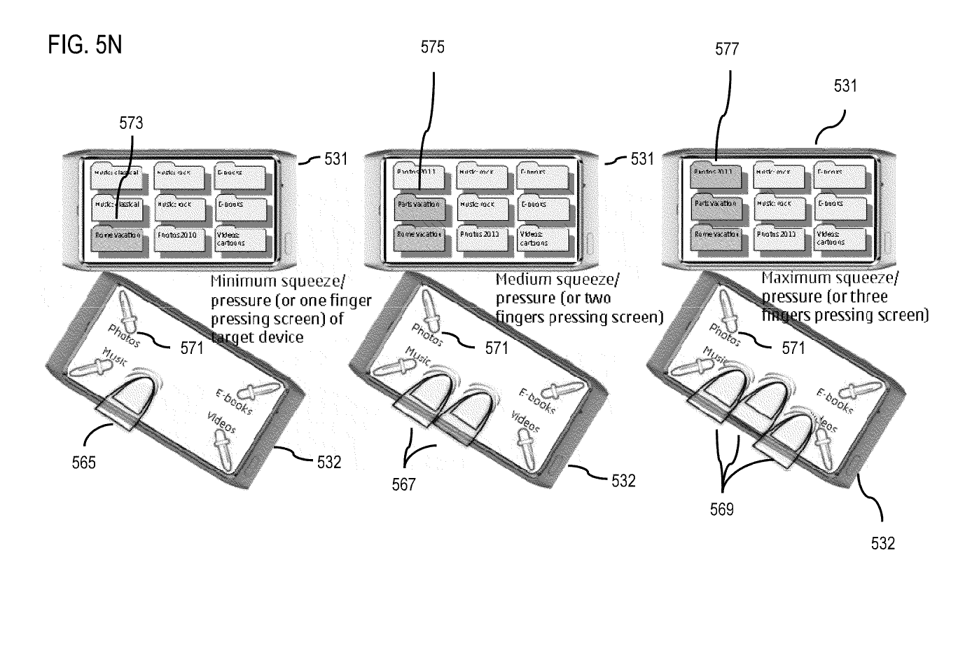

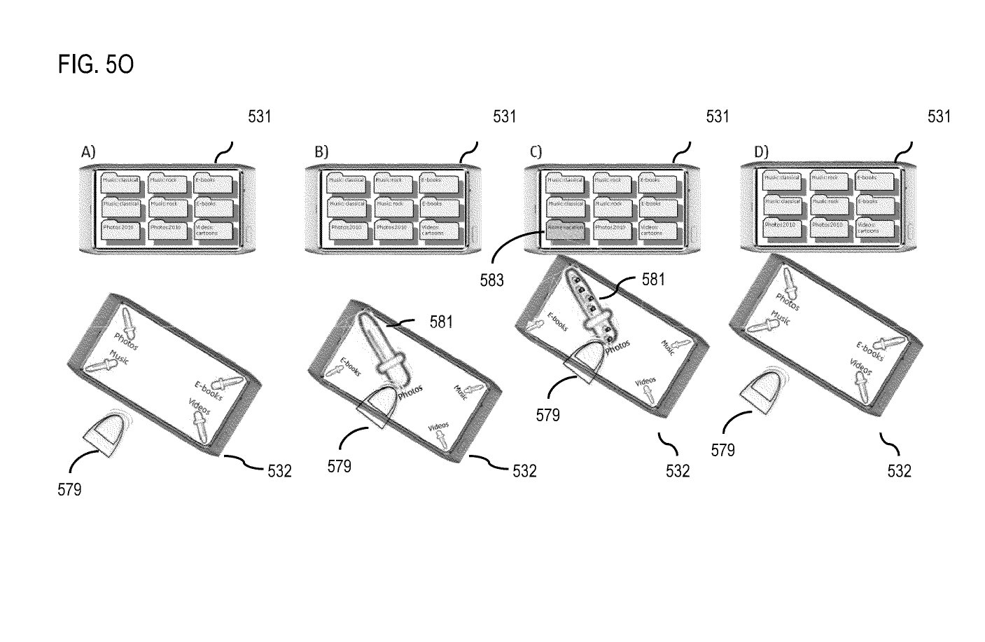

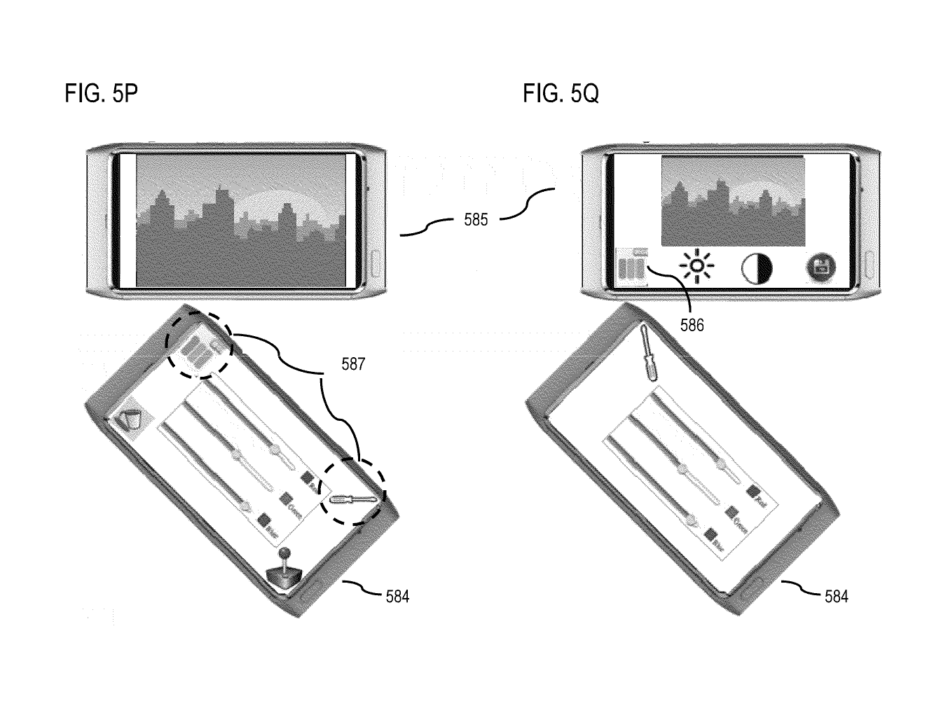

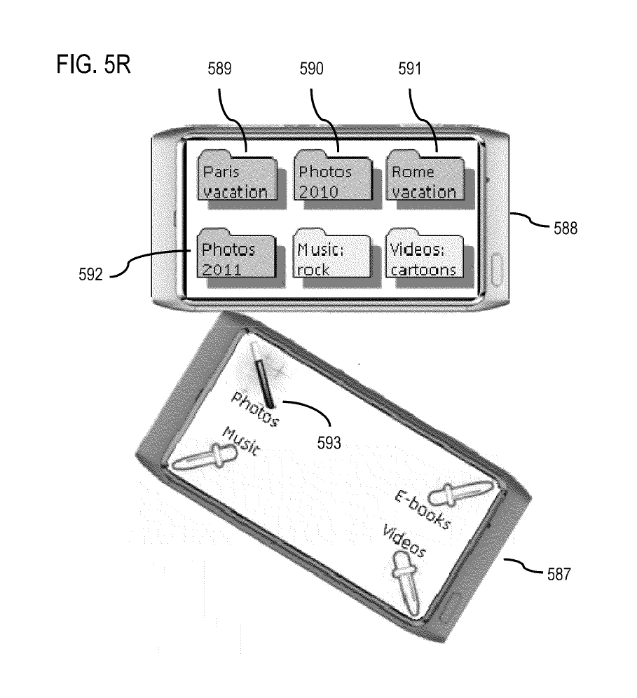

FIGS. 5A-5R are diagrams depicting an interaction between one or more devices for enabling controlled selection and copying of files, according to various embodiments. By way of example, the diagram pertains to executions performed by the target UE 101a and source UE 101n as they operate in connection with the file sharing processor of FIG. 1. In particular, the device interaction includes initiation of the file selection and/or transfer process on the basis of determined overlap, proximity and other means of interaction between respective devices. It is noted that in certain implementations, each device may operate the same or an independent file sharing processor 111.

FIG. 5A depicts an interaction wherein the selected screen area (drawn area) of a display at a target device 502 defines the size of the subset of files to be copied. The target device 502, as operated by User 2, is able to interact with a source device 500 of User 1 for accessing various files. The interaction, with operational steps labeled A through F, is as follows:
A. The source device 500 presents to its display 505 one or more representations via a file viewer application. In this example, the one or more representations are icons of various folders 501 for referencing one or more files of varying type, size, metadata, etc. The file viewer may present locally stored data or that which is accessed by way of a service (e.g., cloud). By way of example, 15 folders are presented for referencing a total of 1000 files.
B. User 2 selects from the source device all 15 folders (1000 files), corresponding to selection 507. This is done by way of a hand 503 gesture in the form of a sweeping motion across the entire display 505 of the source device 500. For example purposes, the folders represent the entire music collection of User 1.
C. User 2 then selects a copy selection command action 509 to initiate the copy process. For example purposes, the 15 folders are shown in a highlighted/shaded form corresponding to the selection 507.
D. At the target device 502, User 2 draws an area 511 of the display 504 to facilitate partial copying. By way of example, 25% of the display 504 is drawn to (e.g., via a hand 503 gesture). As noted, the percentage of files from the original selection 507 is defined as proportional to the drawn area 511 of the display 504.
E. User 2 selects a paste command action 513 at the target device 502. By way of example, the paste command action 513 specifies that the user is to paste 25% of the selected files 507 to the target device 502. It is noted that the file sharing processor 111 may be caused to render the paste command action 513 to the display 504 automatically in response to the drawn area 511 gesture as previously performed.
F. All 15 folders from the selection 507 are presented to the display 504 of the target device 502 as copied. However, only 25% of the 1000 files or 250 are actually copied. The actual files copied correspond to those music files matching predetermined selection criteria.

FIG. 5B depicts an interaction wherein the overlapping screen area of a display at a target device 502 defines the size of the subset of files to be copied. The target device 502, as operated by User 2, is able to interact with a source device 500 of User 1 for accessing various files. The interaction, with operational steps labeled G through L, is as follows:
G. The source device 500 presents to its display 505 one or more representations via a file viewer application. In this example, the one or more representations are icons of various folders 501 for referencing one or more files of varying type, size, metadata, etc. By way of example, 15 folders are presented for referencing a total of 1000 files. A target device 502 is also placed within proximity of the source device 500, such as to fulfill a proximity condition for initiating a file sharing interaction.
H. User 2 places the target device 502 atop the source device 500 such that they are in an overlapping position. By way of example, the display 504 of the target device 502 is caused to operate in a transparency mode, such that content at the display 505 of the source 500 is replicated. Hence, the 15 folders totaling 1000 files at the source device 500 is shown at the display 504 of the target.
I. User 2 slides the target device 502 across the display 505 of the source device 500 in order to define a selection 507. By way of example, the selection includes all 15 folders (1000 files) as presented. The file sharing processor 111 is able to interpret the sliding gesture as performed by way of one or more sensors at the source device 500 and target device 502. As a result of the sliding gesture, a copy selection command action 509 is presented to User 2 to initiate the copy process. For example purposes, the 15 folders are shown in a highlighted/shaded form corresponding to the selection 507.
J. User 2 slides the target device 502 across a portion of the display of the source device 500, resulting in a partial overlapping of the source and target devices 500 and 502 respectively. By way of example, the display 504 of the target device 502 is caused to operate in a transparency mode, such that content at the display 505 of the source 500 is replicated to the extent of overlap. Hence, partial overlapping of 25% of the screen area of the source device 500 and target device 502 determines the number of files.
   It is noted that this approach varies from that presented with respect to FIG. 5A given that the amount/number of files to be copied per the selection 507 is defined by sliding the display of the target device 502 across an area 510 of the display of the source device 500 (steps B and C in FIG. 2). The subset of files to be copied is defined by the size of the overlapping screen areas of the source device 500 and target device 502.
K. User 2 selects a paste command action 513 at the target device 502. By way of example, the paste command action 513 specifies that the user is to paste 25% of the selected files 507 to the target device 502—i.e., 25% screen area. It is noted that the file sharing processor 111 may be caused to render the paste command action 513 to the display 504 automatically in response to the drawn area 511 gesture as previously performed.
L. All 15 folders from the selection 507 are presented to the display 504 of the target device 502 as copied. However, only 25% of the 1000 files or 250 are actually copied. The actual files copied correspond to those music files matching predetermined selection criteria.

FIG. 5C depicts an interaction wherein the subset of files to be copied is determined for selection by way of one or more keywords. The target device 502, as operated by User 2, is able to interact with a source device 500 of User 1 for accessing various files. The interaction, with operational steps labeled M through S, is as follows:

Steps M-Q are identical to steps A-E of FIG. 5A.
R. Keywords describing all files corresponding to the selection 507 are retrieved from the metadata of the files. By way of example, the metadata may be a rating (e.g., a number of stars), statistical data (e.g., the top 50 chart position of a song), etc. Keywords as culled from the files are grouped and presented to the display 504 of the target device 502 as a list. Keywords may be selected from the list by User 2 for restricting the selection 507 to those files corresponding to the keyword. Hence, by way of example, selection of the keyword “Rap” 514 results in a subset of files corresponding to only this genre of music. It is noted that multiple keywords may be selected for enabling the search. Also, the file sharing processor 111 may generate a message for indicating if a chosen keyword does not fill the 25% quota (per the defined area 511 of step P), or if it exceeds it substantially.
S. All 15 folders from the selection 507 are presented to the display 504 of the target device 502. However, of the 1000 files, only 250 are actually copied (25%), representing those tagged (with metadata) as Rap music. It is noted that only files with distinguishable metadata can be culled accordingly for generating the subset. The files matching the selected keywords are transferred to the target device.

FIG. 5D depicts an interaction wherein the subset of files to be copied is determined based on a folding of the source device. The source device 500, as operated by User 1, is able to interact with a target device 502 of User 2 to facilitate file copying and/or transference. The interaction, with operational steps labeled T through 2, is as follows:
T. The source device 500 presents to its display 505 icons of various folders 501 for referencing one or more files of varying type, size, metadata, etc. The file viewer may present locally stored data or that which is accessed by way of a service (e.g., cloud). By way of example, 15 folders are presented for referencing a total of 1000 files. However, by way of example, User 2 makes a selection 530 of four of the folders for referencing 100 files in total.
U. User 2 then selects a copy selection command action 509 to initiate the copy process. By way of example, the file sharing processor 111 enables a partial copy corresponding to the selection 530.
V. User 2 folds the source device in half. By way of example, the amount of folding corresponds to the number of files from the selection 530 to be copied.
W. A proximity condition or overlapping between the source device 500 and target device 502 is detected. As a result, 50% of the files from the four selected folders are copied from source device to target device—i.e., based on the 50% change in form factor or size of the source device 500. By way of example, the file sharing processor 111 initiates the copying process by placing the folded source device 500 on top of the target device 502.

FIGS. 5E-5R are diagrams depicting an interaction between one or more devices for enabling controlled selection and copying of files, according to various embodiments. By way of example, the diagram pertains to executions performed by the target UE 101a and source UE 101n as the selection and/or transfer process if facilitated via a pipette tool, magnet or other icon to be associated with the selection criteria as the operate in connection with the file sharing processor of FIG. 1. It is noted that in certain implementations, each device may operate the same or an independent file sharing processor 111.

The general interaction between the devices based on this transfer process is outlined in operational steps 1-7 below:
1. Determine the location or proximity of the target device and source device relative to each other.
2. Determine folders and/or files corresponding to that location that are represented to the GUI of the source device.
3. Determine which corner of the target device is nearest to the source device.
4. Obtain media type(s) or keyword(s) defined by user for the data extraction and/or attraction tool, i.e., the copy-pipette, corresponding to that corner of the target device.
5. Send a query to the source device for those files corresponding to the keyword.
6. The source device transfers to target device those items matching the query. The folders or files that are sent may be limited to those that currently appearing in the source device GUI. Files marked as “private” on the source device may not be transferred.
7. At the source device, a color of a folder may indicate if there is a match between the keyword associated with the corresponding copy-pipette tool and one or more files in the folder.

With regards to the final step, optionally only files from the folder appearing in the target device GUI next to the corresponding corner of the target device need be copied.

It is noted that the above described operational flows are general and that various other approaches and implementations may be employed. The file sharing processor 111 may be adapted to accommodate varying operations and device interactions.

FIG. 5E depicts an interaction wherein a source device 531, featuring various file folders, enables the transfer of files to a target device 532. The process is initiated when a corner of the target device 532 touches a location on the side of the source device 531. Alternatively, the devices 531 and 532 do not touch but can be in close proximity or may be caused to overlap to some extent. By way of example, each corner of the target device 532 may have a specific “copy-pipette” tool 533 setting defining with keywords the types of files are to be copied to the target device 532. In this example, the keyword associated with the pipette tool 533 is “Photos.” For the purpose of example, this keyword represents criteria for designating the specific type of media that is allowed to be extracted and/or attracted by way of this pipette. The other pipettes, as rendered to the interface in various other corners of the device 532, correspond to keywords “E-books”, “Music” and “Videos.” By way of example, the source device 531 has a single folder 537 with many types of media files. However, when the pipette tool 533 is directed towards this folder 537 only photos are copied to the target device 532 given that the keyword associated with the copy-pipette is “Photos.”

The user has the option of directing a different corner of the device 532 towards the various folders of source device 531. As such, the corresponding pipette and keyword at the corner enables the user to quickly obtain a different type of content. FIG. 5F depicts the same interaction as in FIG. 5E, but with user of a “copy magnet” 535. The copy magnet is directed towards a folder 539 of the source device 531 for attracting only music related files. Under this scenario, files on the source device 531 are shown to exhibit a polarity response (e.g., photo files may possess a negative pole, and audio files a positive pole). As such, the target device 532 pulls files from the source device 531 that have an opposite polarity to the currently chosen side of the magnet. This metaphor may be used to synchronize only certain folders or types of content between the two devices.

FIG. 5G depicts an interaction between the target device 532 and the source device 531 for facilitating network based data transfer. By way of example, the files to be copied to the target device 531 may be stored locally on the source device 531 in certain embodiments. Alternatively, the files may be stored in a cloud based service 541 accessible by way of a network. Under this scenario, the pipette tool 533 corresponding to the contacting/proximal corner of target device 532 initiates the file querying process based on the keyword “Photos.” This causes the source device 531 to query a cloud service 541 to which it has access for files matching the keyword as per selection of folder 537. As a result, the cloud service 541 transmits the files corresponding to the keyword criteria.

FIG. 5H depicts an interaction between the target device 532 and the source device 531 for facilitating multiple folder file selection. In this scenario, starting from the left, only photo files from a folder entitled “Rome vacation” 532 of the source device 531 are copied to the target device 532. As noted, various other types of media files may be in the folder 532, but are copied per use (selection for copy) via the pipette tool 533. The user may then moves the target device 532 along the side of the source device 531, as represented by the sliding action 545, to obtain photo files from other folders as represented to the user interface. By way of example, a folder 543 contains various files, including one or more files that conform to various imaging formats. Files matching the pipette keyword from all folders appearing in a grid on the screen of the source device 531 are therefore copied. It is noted that the grid may correspond to a series of columns and rows of folders and/or files as presented to a display. Other configurations, including circular or random patterns, may also be accounted for.

FIG. 5H depicts operation of the target device 532 for enabling criteria to be defined for enabling file selection and/or transfer from a source device. In FIG. 5I, the user may define several keywords 549 and associate these as criteria for a pipette tool 547. Subsequently, as depicted with respect to In FIG. 5J, the user then hand 548 selects a particular keyword 550 to activate for enabling file selection. In certain embodiments, each corner of the display of the device 532 may feature a pre-set list of keywords for the user to choose from and then associate with the pipette tool 547. It is noted as well that the user may define various proprietary file types and formats for use in connection with the pipette 547 or other data extraction and/or attraction tool.

In addition to specific media types, the pipette tool 547 may also be associated with complete search sentences 551 as criteria. This is depicted in FIG. 5K. The sentences may include a combination of generic keywords and Boolean operators for establishing conditional copy criteria, as shown. By way of example, a condition of “LAST 7 DAYS” or PARIS AND EIFFEL restrict the files to be copied to only those matching such criteria. In the case of the *.JPG and NOT *.RAW criteria, the file types to be copied to the target 532 are automatically aligned with the proper CODECS installed on the target device 532.

Still further, in FIG. 5L, the current keywords may also be chosen by way of a drag-and-drop from a wheel-arrangement. The wheel 553 may be rotated on the touch screen. In certain embodiments, there may be multiple overlaid wheels (not shown) for enabling a user of the target device 532 to quickly try out different combinations of keywords for use as criteria to be associated with a given pipette tool. Under this scenario, one wheel could be dedicated to defining specific file types to be subject to selection and/or transfer, another for defining Boolean operators, a third for a time stamp, a fourth for defining a file size, etc.

FIG. 5M depicts an interaction between the target device 532 and the source device 531 for using pressure to control source folder selection and/or transfer parameters. By way of example, the amount of pressure as applied by the user to the target device 532 from squeezing is determined. Alternatively, an amount of pressure as applied to the user interface of the target device 532 from pressing with a certain number of fingers can be determined. The number of fingers is then translated into a requisite value for defining the amount of content that is copied from a source device 531, or the rate of transfer of content from the source device 531. Under this scenario, the file sharing processor 111 causes a visualization of the data transfer at the corresponding rate such that the user can see icons of the copied files appearing in the pipette tool squeeze element (e.g., 555).

Also, the amount of pressure or number of fingers pressing the screen may define from how many rows in a grid content is transferred. By way of example, the number of fingers pressing the screen of the target device defines how much of the content matching the keyword is copied from the source device. Under this scenario, one finger 565 corresponds to a 33% selection of content corresponding to the criteria (e.g., from folder 559 containing various photos), two fingers 567 corresponds to a 66% selection of content corresponding to the criteria (e.g., from folders 559 and 561) and three fingers corresponds to 100% of the selection, i.e., all file folders 559, 561 and 563 containing photos. The number of fingers and the amount of pressure from each finger may be combined for the input as well. In addition, the size of the pipette tool 557a-557c as well as its corresponding element 555a-555c may be enlarged to indicate to the user how much data will be transferred from the source device 531. In certain embodiments, thumbnail icons of the transferred files may appear in the pipette tool squeeze element 555a-555c. Also, icons of the other pipette tools may be shrunken in size while the pipette 557 performing the extraction is in use.

FIG. 5N depicts varying degrees of pressure being applied to a target device for facilitating the selection and/or transfer of data from the source. By way of example, the vertical (or horizontal) depth of folders in a grid on the source device 531 is determined by the amount of pressure on the target device 532 as the pipette tool 571 is directed to a particular column or row of the grid. A first pressure level may correspond to a single finger 565 touch and hence a single folder 573 depth, a second pressure corresponding to a two finger touch and hence a double folder 575 depth, and a third corresponding to a third (highest) level of pressure and folder 577 depth.

FIG. 5O depicts an interaction between the source device 531 and the target device 532 wherein the pipette tool as rendered to the interface mimics the operation of a physical pipette. Various interaction scenarios are labeled as A-D accordingly. In A), the user does not press the target device 532—i.e., the user's finger 579 is away from the source device 531. In B), the user then presses the squeeze element of the pipette tool 581 nearest to the source device 531. In C), the user moves the target device 532 closer to the source device 531 while continually activating the squeeze element of the pipette tool 581. This starts the file transfer from the source device 531 to the target device 532. Thumbnails of copied files also appear in the pipette tool 581 in the same manner a liquid would appear as a result of reverse air pressure pulling the liquid into the pipette. In D), the user lifts their finger 579 from the target device 532, which halts the file transfer process even though the devices are next to each other.

It is noted that the above described interaction wherein the pipette tool 581 is used to extract files can also be applied inversely to permit the copying of files. Under this scenario, the device with the “pipette tool” metaphorically acts as a “droplet tool” for depositing files. In this example, the keyword associated with the pipette tool 581 is “Photos” so folders at the source device, such as folder 583, are highlighted as potential targets for file deposit. The user would apply pressure to the squeeze element of the droplet to facilitate the file transfer.

In addition to exchanging files, another embodiment of the invention contemplates that a control device 584 modifies parameters on a target device 585. This is presented, by way of example, with respect to FIGS. 5P and 5Q. With reference to 5O, the parameters are defined by the keywords, symbols or icons 587 as rendered to the corners of the interface of the control device 584. There may also be additional inputs such as software sliders on the “control” device for modifying a parameter or other interactive elements. Under this scenario, one icon corresponds to a tool for adjusting the RGB values of a photograph or image as presented at the display of the target device 585.

In FIG. 5P, the function that is modified is chosen by placing a corner of the control device 584 next to an icon 586 on the target device 585. In this example, the selected controller 586 functions to enable adjusting the RGB values of a photograph. In certain embodiments, the control inputs on the control device 585 change as one corner of the device is moved next to a new icon on the target device 584.

FIG. 5R depicts an interaction wherein the source folders 589-592 for file transfer are also defined at the target device 587 with a “keyword magic wand” tool 593. By way of this approach, all visible folders at the source device 588 or files (or all files on the device) matching the keyword presented at a corner of a display of the target device 587 are set as the copy source. By changing the keywords or adding keywords to be associated with the wand tool 593, the user of the target device 587 can quickly experiment with the different selections.

For the various examples discussed herein, it is noted that the relative spatial position of the devices can be determined by using different sensors. This may include, for example, the user of radio frequency identifier readers and tags, or infrared transmitters and receivers. Alternatively, tracking technologies may be based on ultrasound or on radio. Additionally, infrared sensors may be used to determine when the devices are touching each other, while gyroscopes and other sensors may be used to determine relative position and orientation. In certain embodiments, the data transfer between the devices may occur over close-proximity radio such as Bluetooth and WiFi.

With appropriate device location tracking technology, a target device may also be placed on top of the source device display to use the pipette tool. Multiple folders may be selected, such as by drawing a circular shape with one corner of the target device (e.g., a lasso tool). Also, the magic wand tool 593 may be used.

It is noted that in instances where no content on the source device exactly matches the keywords/criteria associated with the pipette tool, the file sharing processor 111 may highlight folders with similar content in the source device. For example, if the user is searching for ‘PHOTOS AND ROME, the file sharing processor 111 highlights a folder with photos from Milan.

It is contemplated that an attempted transfer of a file marked as “private” or “confidential” results in the file getting stuck in the pipette. This visually depicts to the requesting user that they have to shake the source device to confirm that they are allowed access to the file to be copied. The shake may deny or confirm access—i.e., deny copying by tilting the device towards the user.

While the above described interactions are presented from the perspective of two different users, it is noted that the steps may be performed by a single user. Furthermore, the executions as described may vary from the examples depending on the implementation requirements of the source and target devices. The file sharing processor 111 may be adapted to accommodate varying device, user, file access and network communication requirements.

The processes described herein for enabling controlled selection and copying of files from a source to a target device may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

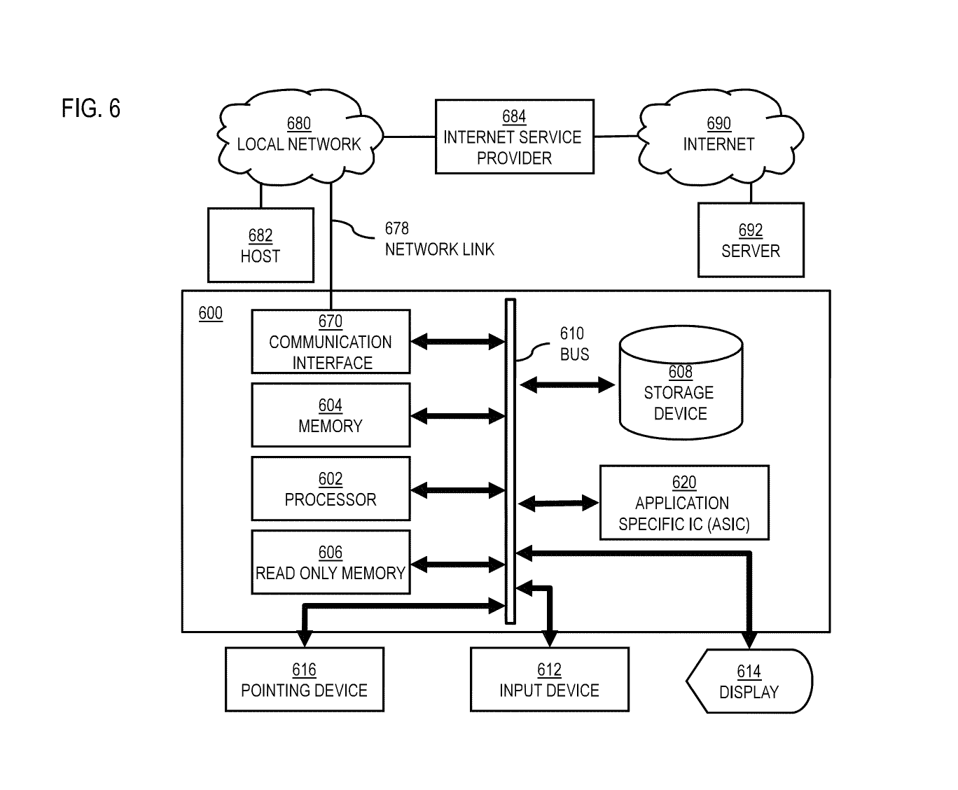

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to enable controlled selection and copying of files from a source to a target device as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of enabling controlled selection and copying of files from a source to a target device.

A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to enable controlled selection and copying of files from a source to a target device. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or any other dynamic storage device, stores information including processor instructions for enabling controlled selection and copying of files from a source to a target device. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or any other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for enabling controlled selection and copying of files from a source to a target device, is provided to the bus 610 for use by the processor from an external input device 612, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT), a liquid crystal display (LCD), a light emitting diode (LED) display, an organic LED (OLED) display, a plasma screen, or a printer for presenting text or images, and a pointing device 616, such as a mouse, a trackball, cursor direction keys, or a motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of ASICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for enabling controlled selection and copying of files from a source to a target device to the UE 101.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or any other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set or chip 700 upon which an embodiment of the invention may be implemented. Chip set 700 is programmed to enable controlled selection and copying of files from a source to a target device as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of functions. Chip set or chip 700, or a portion thereof, constitutes a means for performing one or more steps of enabling controlled selection and copying of files from a source to a target device.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to enable controlled selection and copying of files from a source to a target device. The memory 705 also stores the data associated with or generated by the execution of the inventive steps.

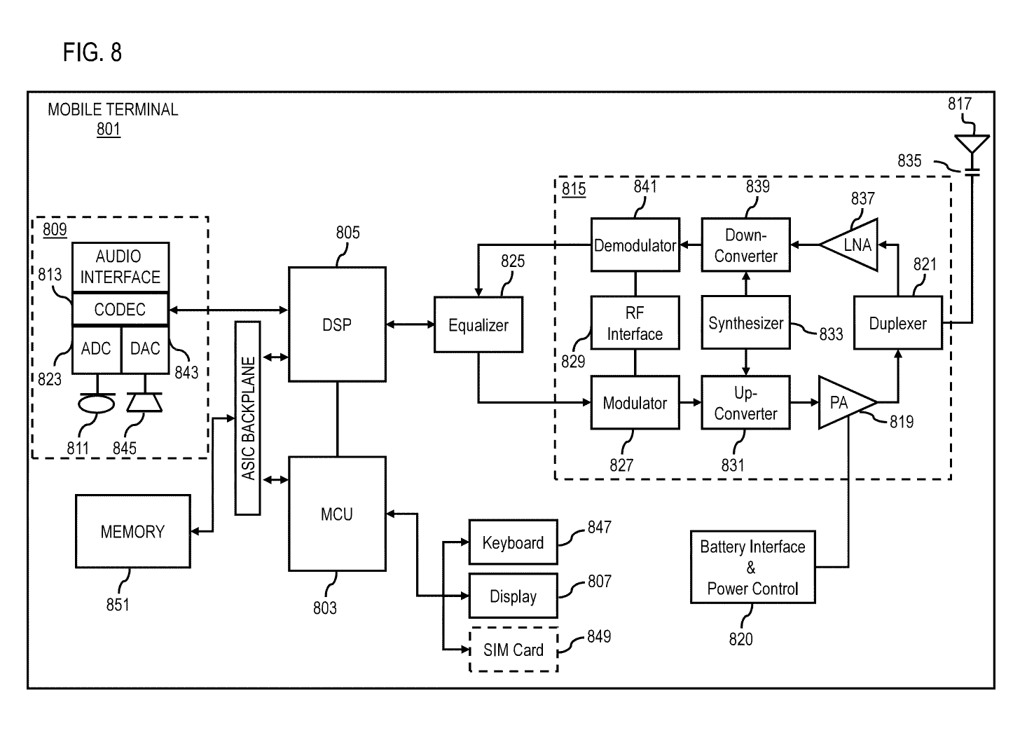

FIG. 8 is a diagram of exemplary components of a mobile terminal (e.g., handset) for communications, which is capable of operating in the system of FIG. 1, according to one embodiment. In some embodiments, mobile terminal 801, or a portion thereof, constitutes a means for performing one or more steps of enabling controlled selection and copying of files from a source to a target device. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of enabling controlled selection and copying of files from a source to a target device. The display 807 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803 which can be implemented as a Central Processing Unit (CPU).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to enable controlled selection and copying of files from a source to a target device. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
a processing of positional information associated with a first device and a second device to determine a relative position of the first device with respect to the second device; and
at least one determination of one or more criteria for causing, at least in part, a selection, a transfer, or a combination thereof of one or more files between the first device and the second device based, at least in part, on the relative position.

2. A method of claim 1, wherein the (1) data and/or (2) information and/or (3) at least one signal are further based, at least in part, on the following:
a rendering of a first user interface at the first device, a second user interface at the second device, or a combination thereof, for presenting, at least in part, one or more representations of the one or more criteria.

3. A method of claim 2, wherein the (1) data and/or (2) information and/or (3) at least one signal are further based, at least in part, on the following:
a rendering of the one or more representations at one or more locations of the first user interface, the second user interface, or a combination thereof; and
at least one determination of a proximity of the one or more representations between the first user interface, the second user interface, or a combination thereof based, at least in part, on the relative position,
wherein the one or more criteria are determined based, at least in part, on the proximity.

4. A method of claim 2, wherein the one or more criteria include, at least in part, one or more file types, one or more keywords, or a combination thereof.

5. A method of claim 2, wherein the first user interface includes, at least in part, one or more control elements for manipulating, processing, or a combination thereof the one or more files rendered in the second user interface.

6. A method of claim 2, wherein the (1) data and/or (2) information and/or (3) at least one signal are further based, at least in part, on the following:
an input via the first user interface, the second user interface, or a combination thereof for specifying one or more areas that define, at least in part, one or more sets of the one or more files for the selection, the transfer, or a combination thereof.

7. A method of claim 1, wherein the (1) data and/or (2) information and/or (3) at least one signal are further based, at least in part, on the following:
a processing of the relative position to determine an amount of overlap between the first user interface and the second user interface; and
at least one determination of the one or more areas based, at least in part, on the amount of overlap.

8. A method of claim 7, wherein the one or more areas encompass one or more icons representing the one or more sets of the one or more files, the one or more files, or a combination thereof.

9. A method of claim 1, wherein the (1) data and/or (2) information and/or (3) at least one signal are further based, at least in part, on the following:
at least one determination of interaction information with the one or more representations; and
an initiation of the selection, the transfer, a determination of the one or more criteria, or a combination thereof based, at least in part, on the interaction.

10. A method of claim 9, wherein the interaction information includes, at least in part, multi-touch interaction, touch pressure information, or combination thereof.

11. An apparatus comprising:
at least one processor; and
at least one memory including computer program code for one or more programs, the at least one memory and the computer program code configured to, with the at least one processor, cause the apparatus to perform at least the following,
process and/or facilitate a processing of positional information associated with a first device and a second device to determine a relative position of the first device with respect to the second device; and
determine one or more criteria for causing, at least in part, a selection, a transfer, or a combination thereof of one or more files between the first device and the second device based, at least in part, on the relative position.

12. An apparatus of claim 11, wherein the apparatus is further caused to:
cause, at least in part, a rendering of a first user interface at the first device, a second user interface at the second device, or a combination thereof, for presenting, at least in part, one or more representations of the one or more criteria.

13. An apparatus of claim 12, wherein the apparatus is further caused to:
cause, at least in part, a rendering of the one or more representations at one or more locations of the first user interface, the second user interface, or a combination thereof; and
determine a proximity of the one or more representations between the first user interface, the second user interface, or a combination thereof based, at least in part, on the relative position,
wherein the one or more criteria are determined based, at least in part, on the proximity.

14. An apparatus of claim 12, wherein the one or more criteria include, at least in part, one or more file types, one or more keywords, or a combination thereof.

15. An apparatus of claim 12, wherein the first user interface includes, at least in part, one or more control elements for manipulating, processing, or a combination thereof the one or more files rendered in the second user interface.

16. An apparatus of claim 12, wherein the apparatus is further caused to:
determine an input via the first user interface, the second user interface, or a combination thereof for specifying one or more areas that define, at least in part, one or more sets of the one or more files for the selection, the transfer, or a combination thereof.

17. An apparatus of claim 11, wherein the apparatus is further caused to:
process and/or facilitate a processing of the relative position to determine an amount of overlap between the first user interface and the second user interface; and
determining the one or more areas based, at least in part, on the amount of overlap.

18. An apparatus of claim 17, wherein the one or more areas encompass one or more icons representing the one or more sets of the one or more files, the one or more files, or a combination thereof.

19. An apparatus of claim 11, wherein the apparatus is further caused to:
determine interaction information with the one or more representations; and
cause, at least in part, an initiation of the selection, the transfer, a determination of the one or more criteria, or a combination thereof based, at least in part, on the interaction.

20. An apparatus of claim 19, wherein the interaction information includes, at least in part, multi-touch interaction, touch pressure information, or combination thereof.
